(19) United States
(12) Patent Application Publication
(10) Pub. No.: US 2006/0215689 A1
(43) Pub. Date: Sep. 28, 2006

(54) System-level communication link bonding apparatus and methods

(75) Inventors: Bo Liu, Kanata (CA); Pascal Albert Emile Lefebvre, Brussels (BE); Charles Michael Storry, Kemptville (CA); Bart Joseph Gerard Pauwels, Tessenderlo (BE); Zoltan Balint, Antwerp (BE)

Correspondence Address: ECKERT SEAMANS CHERIN & MELLOTT, LLC., US STEEL TOWER, 600 GRANT STREET, 44TH FLOOR, PITTSBURGH, PA, 15219-2788, US

(73) Assignee: Alcatel

(21) Appl. No.: 11/089,510

(22) Filed: Mar. 24, 2005

(51) Int. Cl. H04J 3/22

(52) U.S. Cl. 370/465

(57) ABSTRACT

Apparatus and methods for communication system-level communication link bonding are disclosed. Multiple communication links provided by transceivers in communication link termination modules are configured as a bonding group to support an aggregate group communication traffic rate on another communication link. Through an internal communication mechanism in communication equipment, communication traffic received on the other communication link is distributed among those of the communication link termination modules which include transceivers for transferring communication traffic on the communication links in the bonding group. The bonding module also receives, from communication link termination modules, communication traffic to be sent on the other communication link.

### FIELD OF THE INVENTION

This invention relates generally to communications and, in particular, to bonding communication links such as Digital Subscriber Line (DSL) connections.

### BACKGROUND

Generally, communication links can provide limited bandwidth or communication rates. For certain types of communication link, including DSL connections for instance, distance and bandwidth are inversely proportional. As the length of a DSL loop line increases, the bandwidth of the loop decreases. DSL services thus tend to be limited in terms of reach, bandwidth, or both.

Communication link bonding, in which multiple communication links are configured as a group, addresses bandwidth or communication traffic rate constraints by allowing communication traffic to be transferred on more than one communication link. Each communication link in a bonding group provides a portion of an aggregate group communication traffic rate. Bonding thereby allows higher communication traffic rates to be maintained over longer distances relative to single-link implementations.

International Telecommunication Union (ITU) Recommendation G.998.1 describes many aspects of bonding DSL lines based on Asynchronous Transfer Mode (ATM), and represents one example of a communication link bonding technique. However, this Recommendation is silent regarding an architectural approach to bonding individual DSL lines, or any other types of communication link, into a group.

There remains a need for communication link bonding schemes which support system-level bonding of communication links provided by multiple communication link termination modules in some communication equipment architectures, for example. This would allow for a more “global” bonding approach, in which any communication links provided by communication equipment, not just those supported in a single chipset or a single line termination card for instance, may be bonded.

### SUMMARY OF THE INVENTION

Embodiments of the invention provide an architecture for bonding communication links, illustratively ATM-based bonding of DSL lines such as Asymmetric DSL (ADSL), Very high speed DSL (VDSL), or more generally any DSL (xDSL) lines. Communication links are logically bonded into a group to increase access bandwidth to a given Customer Premises Equipment terminal (CPE), for instance. In one embodiment, multiple local loop pairs are bonded so as to increase a subscriber's DSL bandwidth.

Communication equipment such as DSL Access Multiplexers (DSLAMs) which includes a communication network termination, line terminations, and transceivers connected to communication lines, for example, may benefit from bonding communication lines at a bonding point in a communication path before the line terminations, at the communication network termination or an intermediate module for instance. This type of bonding mechanism addresses specific implementation aspects of communication link bonding which are missing from the above ITU Recommendation, to provide a generic communication equipment-level bonding function.

According to one broad aspect of the invention, there is provided apparatus for managing transfer of communication traffic over communication links, which includes a communication link bonding manager and a bonding module. In one embodiment, the apparatus is for use in communication equipment which includes communication link termination modules adapted to process communication traffic for transfer between respective sets of at least one communication link transceiver and a further communication link on internal communication means.

The communication link bonding manager is adapted to configure multiple communication links, on which communication link transceivers of the communication link termination modules transfer communication traffic, as a group for providing an aggregate group communication traffic rate on the further communication link. The bonding module is provided for connection to the internal communication means, to distribute on the internal communication means communication traffic received on the further communication link among, and to receive on the internal communication means communication traffic to be sent on the further communication link from, communication link termination modules which include the communication link transceivers which transfer communication traffic on the multiple communication links.

The bonding module may distribute the communication traffic in a sequence of transmission data units for transmission on the multiple communication links, and is further adapted to include in each of the transmission data units a sequence identifier indicating a position of the transmission data unit in the sequence of transmission data units. Communication traffic may similarly be received from the communication link termination modules in transmission data units comprising respective sequence identifiers indicating a sequence of the transmission data units. The bonding module then merges the received transmission data units in the sequence indicated by the sequence identifiers into an aggregate communication traffic stream.

In one embodiment, the bonding module and at least one of the communication link termination modules are implemented in different field replaceable elements of the communication equipment.

Although used for transfer of communication traffic for a bonding group, the internal communication means may be shared by the communication link termination modules and also used to transfer internal non-bonding communications. In one embodiment, internal bonding communications have a higher priority than the internal non-bonding communications.

Internal bonding communications may include both bonding communication traffic and other information, such as information relating to receive and transmit capabilities, and associated delay, of bonded communication links.

According to one embodiment, at least the bonding module is implemented in a network termination module which is adapted to transfer communication traffic between the further communication link and the internal communication means.

The bonding module may instead be implemented in an intermediate module which is adapted to transfer communication traffic between the network termination module and the communication link termination modules on the internal communication means. The bonding manager may, but need not necessarily, be implemented in the intermediate module. For example, the communication link bonding manager and the bonding module may be implemented in the network termination module and the intermediate module, respectively.

Another embodiment of the invention relates to implementing the bonding module in one or more of the communication link termination modules, with a communication link bonding manager being implemented either in a communication link termination module or the network termination module.

Communication equipment in which communication link bonding is provided may be implemented as a hub communication network element. A hub communication network element would be adapted to be operatively coupled to a subtending communication network element, and to establish communication links between the bonding module and a remote bonding module via the subtending communication network element. Communication link bonding for the subtending communication network element, and possibly multiple subtending communication network elements, may thereby be provided by the hub communication network element.

A method of managing transfer of communication traffic over communication links at a communication device is also provided. The method is intended for use with a communication device which includes communication link termination modules adapted to process communication traffic for transfer between respective sets of at least one communication link transceiver and a further communication link on internal communication means.

The method includes operations of configuring multiple communication links, on which communication link transceivers of the communication link termination modules transfer communication traffic, as a group for providing an aggregate group communication traffic rate on the further communication link, and distributing on the internal communication means communication traffic received on the further communication link among, and receiving on the internal communication means communication traffic to be sent on the further communication link from, communication link termination modules comprising the communication link transceivers which transfer communication traffic on the multiple communication links.

According to another broad aspect of the invention, there is provided a communication device which includes internal communication means, a network termination device, line termination devices, and bonding means.

The network termination device is operatively coupled to the internal communication means for transferring communication traffic between a communication network and the internal communication means. The line termination devices are operatively coupled to the network termination device through the internal communication means and include transceivers to be operatively coupled to communication lines, and are for processing communication traffic for transfer between the network termination device and the transceivers on the internal communication means.

The bonding means are operative to configure multiple communication lines as a bonding group to provide an aggregate group communication traffic rate, and to distribute on the internal communication means communication traffic received from the communication network to, and receive on the internal communication means communication traffic to be sent on the further communication link from, each of the line termination devices which includes transceivers for transferring communication traffic on any of the communication lines of the bonding group.

Various architectures for implementing the bonding means, in the network termination device, in one or more of the line termination devices, or in an intermediate module, for example, are contemplated.

Other aspects and features of the present invention will become apparent to those ordinarily skilled in the art upon review of the following description of specific illustrative embodiments thereof.

### BRIEF DESCRIPTION OF THE DRAWINGS

Examples of embodiments of the invention will now be described in greater detail with reference to the accompanying drawings, in which:

FIG. 1 is a block diagram of a communication system in which embodiments of the invention may be implemented;

FIG. 2 is a block diagram of a communication device incorporating an embodiment of the invention;

FIG. 3 is a block diagram of a communication device incorporating another embodiment of the invention;

FIG. 4 is a block diagram of a communication device in which yet another embodiment of the invention is implemented;

FIG. 5 is a block diagram of a communication system in which communication link bonding in accordance with an embodiment of the invention is implemented; and

FIG. 6 is a flow diagram of a method according to another embodiment of the invention.

### DETAILED DESCRIPTION OF PREFERRED EMBODIMENTS

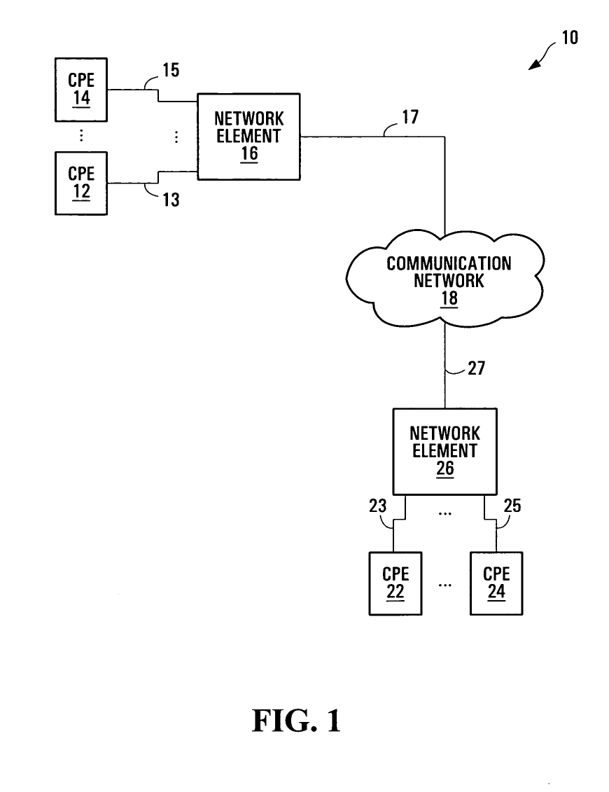

FIG. 1 is a block diagram of a communication system in which embodiments of the invention may be implemented. The communication system 10 in FIG. 1 includes CPEs 12, 14, 22, 24, network elements 16, 26, and a communication network 18. Although only four CPEs 12, 14, 22, 24 and two network elements 16, 26 have been shown in FIG. 1 to avoid congestion, many more CPEs and network elements may be connected to the communication network 18. It should therefore be appreciated that the system of FIG. 1, as well as the contents of the other drawings, are intended solely for illustrative purposes, and that the present invention is in no way limited to the particular example embodiments explicitly shown in the drawings and described herein.

The CPEs 12, 14, 22, 24 represent communication equipment, illustratively end user communication devices, configured to receive and/or transmit communication traffic. Although shown as being directly connected to the network elements 16, 26, it will be apparent that CPEs 12, 14, 22, 24 may communicate with the network elements 16, 26 through other intermediate components (not shown). In one embodiment, the connections 13, 15, 23, 25 are local twisted pair loops used to establish DSL communication links.

Switches and routers are illustrative of the types of communication equipment represented by the network elements 16, 26. For example, where the connections 13, 15, 23, 25 are DSL connections, the network elements 16, 26 may be DSLAMs or Advanced Services Access Managers (ASAMs) or Intelligent Services Access Managers (ISAMs). The network elements 16, 26 provide access to the communication network 18 for the CPEs 12, 14, 22, 24, and thus may be implemented within the communication network 18. However, the network elements 16, 26 have been shown separately from the communication network 18 in FIG. 1 for illustrative purposes.

The communication network 18, in addition to the network elements 16, 26, may also include intermediate network elements which route communication traffic through the communication network 18. Embodiments of the invention may provide ATM-based bonding of DSL lines, as described briefly above, where the communication network 18 is an ATM network and ATM Virtual Circuits (VCs) are established on the connections 17, 27.

Many different types of end user, intermediate, and network communication equipment, as well as the operation thereof, will be apparent to those skilled in the art. In general, the network elements 16, 26 transfer communication traffic between the communication network 18 and the CPEs 12, 14, 22, 24. In particular example embodiments, the network elements 16, 26 exchange communication traffic over ATM, and use ATM-based bonding to transfer communication traffic with the CPEs 12, 14, 22, 24 over DSL connections. However, as will become apparent from the following description, embodiments of the invention are not limited to any particular types of communication equipment, transfer mechanisms, or protocols. The bonding techniques disclosed herein may be used in conjunction with Ethernet network connections instead of ATM connections, and Ethernet- or packet-based bonding instead of ATM-based bonding, for instance.

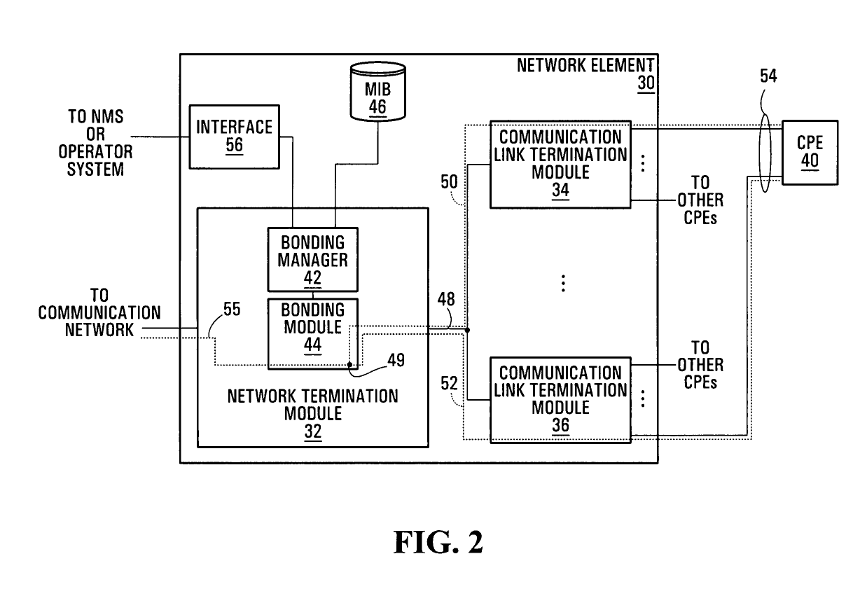

FIG. 2 is a block diagram of a communication device, illustratively a network element 30, incorporating an embodiment of the invention. As shown, the network element 30 includes a network termination module 32 and one or more communication link termination modules, two of which are shown at 34, 36. The network termination module 32 includes a communication link bonding manager 42 and a bonding module 44, and is operatively coupled to the communication link termination modules 34, 36 through internal connections represented at 48. Although referred to herein primarily as an internal bus, the internal connections 48 may instead be implemented using point to point links or other types of connection or link.

Each communication link termination module 34, 36 includes such components as transceivers which provide physical interfaces to a physical communication medium through which communications may be established with the CPE 40 and possibly other CPEs. The Management Information Base (MIB) 46 and the interface 56 are used in some embodiments to configure and manage groups of communication links as described in further detail below.

The network termination module 32 terminates a communication link at a network side of the network element 30, and transfers communication traffic between a communication network link and the internal bus 48. The communication link termination modules 34, 36 terminate access-side communication links at the network element 30, and process communication traffic for transfer between access communication link transceivers and another (network) communication link on the internal bus 48.

One common type of physical structure for communication network equipment such as the network element 30 includes an equipment rack having shelves with multiple electronic card slots. The network termination module 32 may then be provided on a shelf as a network termination (NT) card. Multiple NT cards may be installed on a shelf to support redundancy protection. A line termination (LT) card is then used in each of one or more of the remaining slots as the communication link termination modules 34, 36, to provide a medium- or protocol-specific interface. In this type of installation, the internal bus 48 is often provided as backplane connections on the equipment rack. Although shown in FIG. 2 as being external to the network termination module 32, either or both of the MIB 46 and the interface 56 may be internal to a network termination module.

Details of the structure and operation of various types of network termination module, illustratively NT cards, and communication link termination module, LT cards for instance, will be apparent to those skilled in the art.

The bonding manager 42 and the bonding module 44 may be implemented, for example, in software for execution by a processor in the network termination module 32, in hardware such as a Field Programmable Gate Array (FPGA), or some combination thereof. Distributed architectures are also contemplated. For instance, the bonding manager 42 may be implemented partially in each of the network termination module 32 and another module or circuit card in the network element 30, as described in further detail below.

As will be appreciated by those skilled in the art, each communication link termination module 34, 36 may include modems or some other type of communication components which are adapted to at least transmit, and preferably to transmit and receive, communication traffic on communication links to CPEs. In one embodiment, each LT card in an ASAM includes DSL chipsets which incorporate DSL modems and provide ports as physical interfaces to DSL local loops. An LT card supporting a total of 12-48 access lines may include multiple DSL chipsets, each providing 6-12 ports, for example.

Each CPE 40 for which the network element 30 provides access to a communication network includes a compatible modem or communication component.

The MIB 46 represents management data which is stored in a memory device, preferably a persistent memory device, in the network element 30. The memory device may be provided in the network termination module 32 or externally, as shown.

The Simple Network Management Protocol (SNMP), for example, allows a manager to access management information on a managed device, and for the managed device to send managers unsolicited messages such as notifications, typically when important events occur. An SNMP agent runs in a managed device to interact with managers and access management information on the device. Management information is generally any data defined to manage a device. This is often accomplished by writing descriptions of the management information in MIB modules.

A MIB may include the collection of all management information definitions, although there is no clear distinction between the definitions of management information and the values of that management information. Thus, the same term “MIB”, in reference to a device, may designate all of the management information stored on a device at any instant in time, as well as the definitions of management information which may be written to or modified on a device to manage device functions.

The above-referenced ITU Recommendation describes an example of one possible MIB for ATM-based bonding of DSL lines.

The interface 56 may thus be an SNMP agent, for example, and provides for communication with a Network Management System (NMS) or operator system for configuration of bonding groups as disclosed herein. Control and management information may be transferred between the network element 30 and the NMS or operator system through the interface 56 via the communication network to which the network termination module 32 is connected, or through dedicated control connections or paths. The interface 56 may also or instead include a local interface to enable control and management functions to be performed using a local terminal during service or maintenance of the network element 30.

Although embodiments of the invention relate to communication link bonding, the interface 56 need not necessarily be dedicated to bonding control and management. The interface 56 may be an existing interface which also provides for other control and management functions.

In accordance with an aspect of the invention, multiple communication links are bonded to form a logical group, as disclosed in further detail herein. As shown in FIG. 2, the bonding module 44 which performs the bonding function is provided at the network termination module 32. The bonding function for communication links supported by an ASAM, for example, is then a “global” function for any or all of the links provided by that ASAM. Thus, communication link bonding functions and bonded communication links may be provided in different field replaceable elements, illustratively circuit cards, of communication equipment.

United States Provisional Patent Application Serial No. <Attorney Docket No. 51236-30>, entitled “COMMUNICATION LINK BONDING APPARATUS AND METHODS”, filed on Feb. 9, 2005, and incorporated in its entirety herein by reference, discloses chipset-level bonding to support bonding of communication links provided by a single chipset, and LT-level bonding to support bonding of communication links supported by multiple chipsets or transceivers in a communication link termination module. According to an aspect of the present invention, the bonding module 44 is implemented “upstream” of the communication link termination modules 34, 36, at the network termination module 32 in the network element 30, to support communication equipment-level or system-level bonding. In this type of upstream implementation, any communication links provided by the network element 30, including communication links provided by different modules 34, 36, may be bonded.

Implementation of the bonding module 44 at the network termination module 32 allows any communication links provided by the network element 30 to be bonded, regardless of whether the communication links are provided by the same communication link termination module. In the network element 30, spare capacity in any communication link termination module 34, 36 may be used to provide enhanced service speed or reach to a CPE 40 which is operatively coupled to the same or any other communication link termination module 34, 36 of the network element 30. The CPE 40 need not be moved to a communication link termination module which has spare capacity. In FIG. 2, a spare communication link provided by the communication module 36 may be bonded with a communication link which is provided by the communication link termination module 34 to extend or improve service to the CPE 40.

Transfer of communication traffic over bonded CPE communication links is managed in the network element 30 by the bonding manager 42 and the bonding module 44. The bonding manager 42 is used to configure, at the network termination module 32, multiple communication links to form a group 54. A bonding or merge point is represented at 49 in FIG. 2, with communication links 50, 52 being shown for illustrative purposes as spanning both access communication lines to the CPE 40 and the internal bus 48. The grouped communication links 50, 52 together provide an effective aggregate group communication traffic rate on the network communication link 55 provided by the network termination module 32.

The communication links 50, 52 of a group 54 may, for example, include virtual paths (VPs) which are established between and terminated by bonding end entities, including the bonding module 44 at the network element 30 and another bonding module (not shown) at the CPE 40. The communication traffic rates, illustratively bit rates, of the VPs may be set based on the speed of physical media over which the VPs are established, and a desired aggregate communication traffic rate for the group. The bonding module 44 merges traffic from the VPs, in the upstream or receiving direction, and distributes traffic among the communication link termination modules 34, 36 which transfer communication traffic over the VPs, in the downstream or transmitting direction.

Configuration of communication links as a group may involve setting configuration information in a data store, specifically in the MIB 46 in the network element 30. As described above, the interface 56 provides for control and management of the network element 30 from an NMS or operator system. In one embodiment, the bonding manager 42 configures the group by modifying or storing information in the MIB 46 responsive to user inputs received from the NMS or operator system through the interface 56.

The MIB 46 may include, for example, any or all of the parameters of the MIB described in the above-referenced ITU Recommendation in embodiments supporting ATM-based bonding of DSL lines. A MIB for other types of bonding may include substantially similar or different parameters. The invention is not limited to any particular MIB structure, format, or content.

New MIB parameters may be useful in providing system-level bonding management. For example, the eligibility of a communication link for inclusion in a group may be controlled by a mode parameter, whereby only those communication links having a mode parameter set to “bonding” or a like mode are eligible to be included in a group. A communication link having a mode parameter set to a native or “non-bonding” mode is treated in a conventional manner. Thus, implementation of embodiments of the invention in a network element would not preclude conventional communication traffic processing at the network element, such that the same network element may provide different levels of service to different CPEs. Single or bonded link services may be provided to customers based on bandwidth requirements and the proximity of CPEs to a network element.

A bonding link table or other data structure may also be provided in the MIB 46 to associate a bonded link to a bonding group. In one embodiment, each communication link has an identifier, and the identifier of one communication link in a group is chosen, illustratively by an operator, as a group identifier. A communication link may then be associated with a group by adding the group identifier to a bonding link table entry which corresponds to the communication link. Other possible data structures or tables for mapping or associating links with groups will be apparent to those skilled in the art.

The bonding manager 42 also determines an allocation of the aggregate group communication traffic rate among the communication links in the group. A rate allocation for each communication link may be determined automatically or based on predetermined or manually entered per-link rates or allocations entered by an operator through the interface 56. In general, automatic rate allocation as described below may be preferred so as to match communication traffic distribution to communication link capacities and avoid manual configuration of customer-specified aggregate group communication traffic rates, for example.

The selection of automatic or manual communication traffic rate allocation is an example of another function which might be controlled using a new MIB parameter, illustratively a rate split mode parameter. The rate split mode parameter could be set to “manual” for a group to allow an operator to manually configured communication traffic rates on bonded communication links to address transient noise issues. The operator may be aware of an intermittent interference source which affects a communication link in a bonding group, for instance. In this case, the operator may wish to use predetermined communication traffic rates or manually configure communication traffic rates for the communication links in the group, bypassing the automatic rate splitting function. Thus, a rate splitting mode may be selected on a per-group basis, such that rates for all links of a bonding group are manually configured if at least one communication link in the group is to be manually configured, or rates for all links of a bonding group are automatically allocated.

Automatic communication rate allocation may involve determining respective attainable communication traffic rates of the communication links in a group. A communication traffic rate allocation may then be calculated for each communication link based on the attainable communication traffic rate of that link relative to the total of the attainable communication traffic rates of all of the communication links in the group. One example of an automatic allocation technique is described in further detail below.

The bonding module 44 is operatively coupled to, and preferably incorporated into, the network termination module 32, and distributes communication traffic received on the network communication link 55 for transmission on the bonded communication links 50, 52 in accordance with the communication traffic rate allocation determined by the bonding manager 42. In the other direction, communication traffic received from the CPE 40 over the bonded links is merged by the bonding module 44 at the merge point 49 into an aggregate traffic flow on the communication link 55.

Operation of the bonding module 44 is now described in further detail in the context of ATM-based bonding. It should be appreciated, however, that ATM-based bonding is intended solely for illustrative purposes, and not to limit the scope of the invention. Other types of transmission data unit than ATM cells may be used to transfer communication traffic over bonded communication links in other embodiments of the invention.

Considering first the “downstream” direction, from the network element 30 to the CPE 40, communication traffic received from the communication network and destined for the CPE 40 is formatted into ATM cells, if necessary, which are forwarded to the bonding module 44. According to one embodiment, communication traffic is received from a communication network by the network termination module 32 as Ethernet frames, which are segmented into ATM cells.

ATM cell formatting supports transfer of non-ATM communication traffic via ATM-based bonded communication links, and may be performed by functional components (not shown) such as an Inter-Working Function (IWF) of the network termination module 32. For network elements in which the communication link termination modules 34, 36 normally support the IWF, IWF support is also preferably added to the network termination module 32 for processing at least bonding traffic. Native or non-bonding communication traffic may then still be processed by the IWF on a communication link termination module 34, 36 so as not to place the burden of IWF processing for all traffic on the network termination module 32.

The ATM cells are then output to the bonding module 44. The bonding module 44 inserts a sequence identifier (SID) into each ATM cell, illustratively into the cell header. According to the above ITU Recommendation, the SID is inserted into the Virtual Channel Identifier (VCI) and/or the Virtual Path Identifier (VPI) portions of ATM cell headers, depending on whether 8- or 12-bit SIDs are used. The SID indicates a correct ordering of the ATM cells, to allow a corresponding bonding module at the CPE 40 to properly assemble the transmitted cells to recover an original communication traffic stream. As those skilled in the art will appreciate, different communication links may experience different delays during transmission to the CPE 40, and accordingly cells might not arrive at the CPE 40 in the same order in which they were transmitted from the network element 30.

The bonding module 44 may perform other operations on the ATM cells. For example, the ATM cells may be compressed by removing information from their headers. Header Error Control (HEC) information, as well as VPIs and VCIs if there is no ATM switching performed on bonded communication links, represent examples of redundant information which may be removed from ATM cells in some embodiments.

Addressing information is also preferably added to the ATM cells by the bonding module 44. According to one embodiment of the invention, the communication link termination modules 34, 36 and the bonding module 44 are addressable on the internal bus by respective Source and Destination Media Access Control addresses (SA/DA MAC), and internal bonding communications associated with bonded communication links are identified by a dedicated Virtual Local Area Network (VLAN) tag. Originating and destination DSL port identifiers may also be added to ATM cells by the bonding manager 44, where the bonded communication links are DSL connections.

ATM cells are distributed by the bonding module 44 among the communication link termination modules 34, 36 which provide the bonded communication links via the internal bus 48. This distribution of ATM cells may be handled by a scheduler, illustratively a Weighted Fair Queuing (WFQ) scheduler having weights which are set in accordance with a manually or automatically configured communication traffic rate allocation.

The particular manner in which these functions are implemented may vary between different types of network element. In a network element which receives Ethernet frames from an Ethernet network and also has an Ethernet backplane implemented as a switch fabric capable of handling Ethernet Protocol Data Units (PDUs), for instance, the network termination module 32 might encapsulate ATM cells from the bonding module 44 into Ethernet frames for transfer to the communication link termination modules 34, 36 over the internal bus 48. The communication link termination modules 34, 36 then extract the encapsulated ATM cells from the Ethernet frames for transmission over the bonded CPE links 54. According to one embodiment, each ATM cell from the bonding module 44 is encapsulated into a respective Ethernet frame.

Various other operations may also be performed by the network termination module 32. For example, hardware backpressure signals which are often used in controlling the flow of communication traffic are typically available only at physical communication medium interfaces. Since the bonding module 44 is implemented at the network termination module 32, where hardware backpressure would not normally be provided, an alternate flow control mechanism may be desired. To this end, the network termination module 32 may store received communication traffic in per-group queues and schedule the traffic out of these queues via a rate-limited traffic shaper.

In another embodiment, internal bonding communications transferred on the bus 48 include backpressuring information relating to receive and transmit capabilities, and associated delay, of bonded communication links. For example, the communication link termination modules 34, 36 may provide available backpressuring information to the bonding module 44.

Those skilled in the art will be familiar with further operations which might be performed at the network termination module 32 and at the communication link termination modules 34, 36, for bonded and native communication traffic. Although functional blocks associated with these operations have not been explicitly shown in the drawings, it is to be understood that implementation of embodiments of the invention do not preclude processing of non-bonding traffic according to conventional techniques, and the application of at least some of these techniques, such as backpressuring and scheduling for instance, to bonding traffic as well.

In the upstream direction, the communication link termination modules 34, 36 receive ATM cells from the CPE 40 through the bonded communication links 54, re-format the received cells if necessary, and forward the cells to the network termination module 32 over the internal bus 48. As described above, ATM cells are encapsulated into Ethernet frames where the internal bus 48 is implemented as an Ethernet backplane.

The bonding module 44 uses SIDs inserted into the received cells by a bonding module at the CPE 40 to merge the received cells, in their correct sequence, into an aggregate communication traffic stream for transfer to other functional components of the network termination module 32, such as an IWF. The aggregate traffic stream may be re-formatted, into Ethernet frames for instance, for transmission through the communication network.

As described above, ATM cells transmitted over multiple communication links might not arrive at a destination in the order in which they were transmitted. The bonding module 44 thus preferably buffers ATM cells received from the CPE 40. Received cells may be queued on a per-bonded link basis and grouped on a per-bonding group basis for re-ordering, for example. In this case, all queues in a group share the buffer pool of the group. Alternatively, received cells may be queued in a per-group queue. Each received cell is put in the appropriate position of the queue, based on its SID which may also be used to index the queue. Once the cell at the head of the queue is retrieved from the queue, the whole queue is shifted by one cell position.

With per-link receive queuing, the bonding module 44 may determine a next expected SID based on the SID in one or more queued cells. When all queues are non-empty or at least one queue has been empty for at least the maximum differential delay, which is the maximum transmission delay between communication links of a bonding group, a current SID is initialized to the smallest SID at the head of the per-link queues. Since SIDs are sequentially assigned and wrap around once a predetermined maximum SID, max SID, has been reached, SID wraparound is preferably detected by the bonding module 44. To this end, in one embodiment, an SID x is determined to be less than another SID y if

$$x < y < x + \frac{max SID + 1}{2} .$$

The next expected SID is then calculated as the current SID plus one. A cell having the next expected SID is then retrieved from a per-link queue, if it has been received, and output from the bonding module 44. If the smallest SID at the head of the per-link queues is larger than the next expected SID but all queues are non-empty, then the cell having the smallest SID is retrieved from the per-link queue and output from the bonding module 44. The next expected SID is set to the SID of the last output cell plus one. If the smallest SID at the head of the per-link queues is larger than the next expected SID but at least one queue is empty, the bonding module waits for up to a predetermined amount time, illustratively the maximum differential delay, or until the buffering threshold of the group is reached. Then the smallest SID at the head of the queues is considered the next expected SID. A cell having the next expected SID is retrieved from the queue and output from the bonding module 44.

In the case of per-group queue, a cell is retrieved once it reaches the head of the queue. An empty cell position at the head of the queue is released, i.e., the whole queue is shifted by a cell position, if the cell position at the head of queue has been empty for a predetermined amount of time, such as the maximum differential delay as described above, or the queue threshold is reached.

The bonding module 44 preferably waits up to a predetermined amount of time to receive each expected SID. After a next expected SID is calculated, if at least one queue has been empty for the maximum differential delay, then the smallest SID currently at the head of the queues is then considered the next expected SID. Any cells which then arrive with a smaller SID are discarded, as they have already been considered lost. In this embodiment, the bonding module 44 waits the maximum differential delay before declaring a cell lost. A buffered block of cells may be output from the bonding module 44 or discarded in the event of a cell being declared lost. Other error processing operations which may be performed responsive to cell loss will be apparent to those skilled in the art.

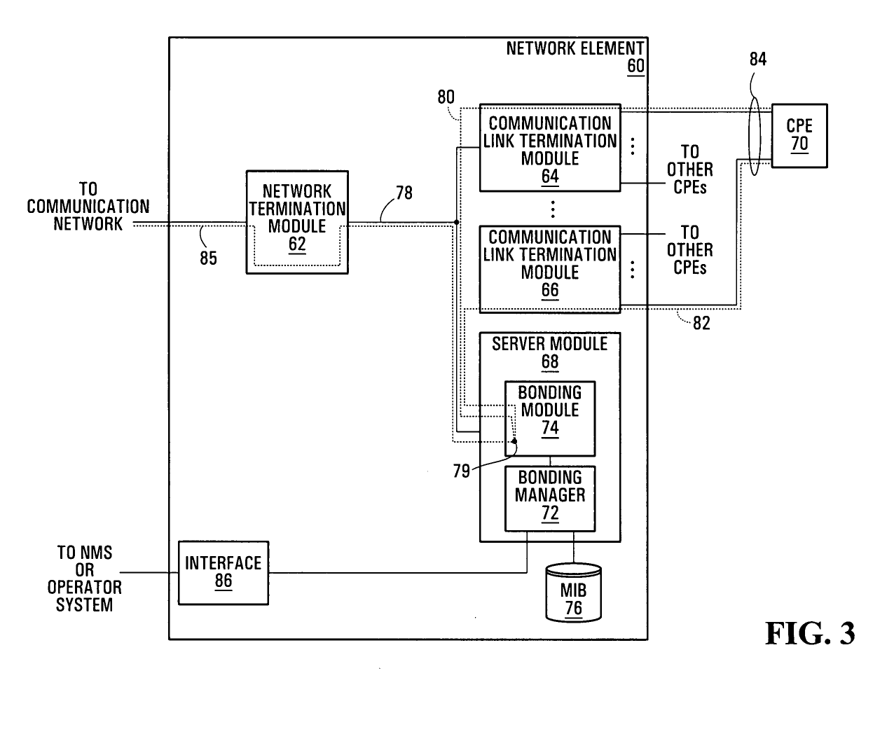

FIG. 3 is a block diagram of a communication device incorporating another embodiment of the invention. The network element 60, like the network element 30 described above, includes a network termination module 62, communication link termination modules 64, 66, a bonding manager 72, a bonding module 74, a MIB 76, and an interface 86, and communicates with a CPE 70 over multiple communication links 80, 82 which have been configured as a group 84. Bonding of the communication links 80, 82 to provide an aggregate communication traffic rate on the network communication link 85 is represented conceptually by the merge point 79.

In the network element 60, the bonding manager 72 and the bonding module 74 are provided in an intermediate server module 68, illustratively a server card, thereby off-loading bonding-related processing from the network termination module 62. Otherwise, the bonding manager 72 and the bonding module 74 operate substantially as described above. Distribution and merging of bonding communication traffic, as well as the IWF for bonding communication traffic in some embodiments, are thus provided by the server module 68. These functions may be supported in software for execution by a processor, hardware such as an FPGA, or some combination of software and hardware.

Although a bonding manager and a bonding module are co-located in FIGS. 2 and 3, in the network termination module 32 and the server module 68, respectively, it should be appreciated that distributed embodiments are also contemplated. For example, management functions performed by the bonding manager 72 may be implemented at the network termination module 62, with traffic distribution and merging functions of the bonding module 74, and possibly other processing-intensive components such as the IWF, being implemented at the server module 68. Different distributions of bonding functions may also be implemented in other embodiments, such as to support some functions of the bonding manager 72 in each of the network termination module 62 and the server module 68.

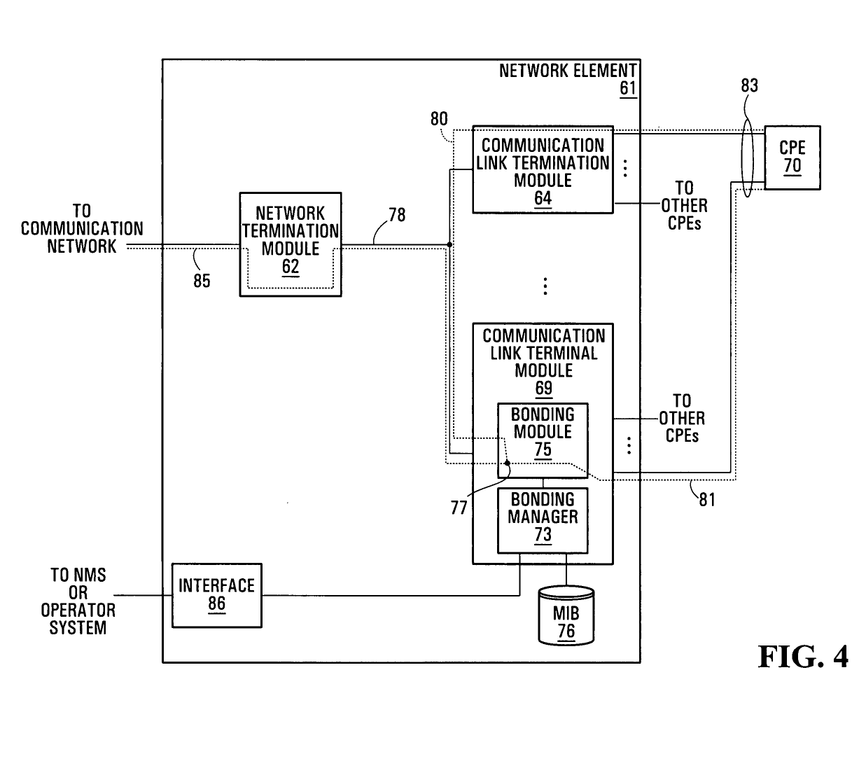

FIG. 4 is a block diagram of a communication device in which yet another embodiment of the invention is implemented. The network element 61 of FIG. 4 is similar in structure to the network element 60 of FIG. 3 and operates in a substantially similar manner. However, in the network element 61, a bonding module 75 is provided in a communication link termination module 69 instead of in a separate server module. The bonding manager 73 may also be implemented at the communication link termination module 69 as shown, or separately, with bonding management functions being at least partially provided at the network termination module 62.

The bonding manager 73 and the bonding module 75 enable communications with a CPE 70 over multiple communication links 80, 81 which have been configured as a group 83 to provide an aggregate communication traffic rate on the network communication link 85. The bonding module 75 distributes communication traffic to, and in some embodiments also merges communication traffic received on, the communication links 80, 81 at a bonding or merge point 77.

The bonding module 75, although supported on a communication link termination module 69, may bond both its own local communication links as well as communication links which are provided by other communication link termination modules, such as 64. As shown, the grouped links 83 include a link 81 which is local to the communication link termination module 69 and a link 80 which is provided by the communication link termination module 64.

The bonding module 75 may process communication traffic somewhat differently, depending upon the communication link over which the communication traffic is to be transmitted or was received. In the context of the above illustrative example of ATM-based bonding and an Ethernet backplane as the internal bus 78, communication traffic received from the network termination module 62 is formatted into ATM cells by the bonding module 75 or another component such as an IWF of the communication link termination module 69. The bonding module 75 adds SIDs to the ATM cells and distributes the cells among the communication link termination modules 64, 69, which transfer communication traffic over the bonded communication links 80, 81 in the group 83. For the local link 81, the bonding module 75 may transfer the ATM cells into per-link queues for scheduling out of the communication link termination module 69 via transceivers or other physical interface components by an existing scheduler. Transfer of ATM cells to the communication link termination module 64, however, may involve additional processing, to encapsulate the ATM cells into Ethernet frames for transfer over the internal bus 78, for example. An IWF in the communication link termination module 64 then extracts the encapsulated ATM packets from the Ethernet frames for transmission to the CPE through its own transceivers.

In the receive direction, inverse communication traffic processing is performed. ATM cells received over the communication links 80, 81 are merged into an aggregate traffic flow by the bonding module 75 and transferred to the network termination module 62. In the case of an Ethernet backplane, the communication link termination module 64 encapsulates ATM cells received from the CPE 70 within Ethernet frames for transfer over the internal bus 78 to the bonding module 75.

As described briefly above, the communication links 80, 81 are established between the bonding module 75 and a corresponding bonding end entity (not shown) at the CPE 70. Neither the network termination module 62 nor the communication link termination module 64 is required to perform any special processing of bonding traffic. These components process native communication traffic and bonding communication traffic in substantially the same manner for transfer over the internal bus 78. The network termination module 62 transfers communication traffic destined for the CPE 70 to the communication line termination module 75, which distributes the traffic among the bonded links 80, 81. The communication link termination module 64 similarly transfers communication traffic received on the link 80 to its endpoint, which is the communication link termination module 69. Communication traffic distribution and merging functions are handled by the bonding module 75.

Implementation of the bonding module 75 at the communication link termination module 69 has several advantages over centralized bonding embodiments in which a bonding module is implemented at a network termination module or a separate dedicated server module. For example, bonding modules may be provided on multiple communication link termination modules to thereby further distribute the processing load of bonding functions. This alleviates processing and bandwidth bottlenecks associated with centralized network termination module- and server-based approaches, while still supporting system-level bonding.

In communication equipment having a circuit card slot architecture, the embodiment shown in FIG. 4 avoids deploying a separate server card in an LT card slot. This may be particularly important for small remote DSLAMs, for instance.

Existing resources on communication link termination modules may also be better utilized by locally implementing bonding module 75. In the network element 30 of FIG. 2, for example, an IWF is preferably provided in the network termination module 32 for handling at least bonding communication traffic. The network element 61 obviates the need for any such adaptation of existing components, in that the communication link termination module 69 would normally provide an IWF which may be used to process both its native traffic and bonding traffic.

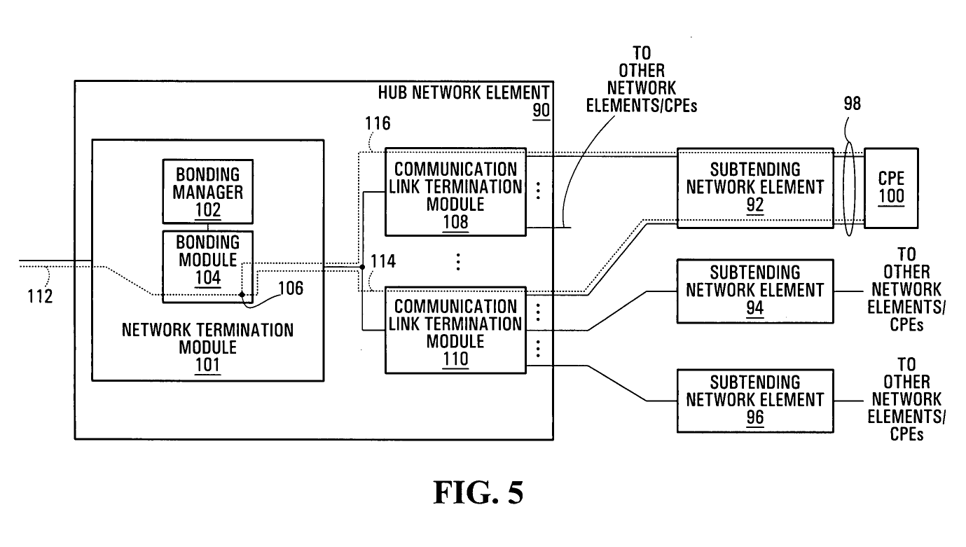

FIG. 5 is a block diagram of a communication system in which communication link bonding in accordance with an embodiment of the invention is implemented. The communication system of FIG. 5 includes a hub network element 90, subtending network elements 92, 94, 96 operatively coupled thereto, and a CPE 100. The hub network element includes a network termination module 101 and communication link termination modules 108, 110.

Communication link bonding is provided at the network termination module 101 by the bonding manager 102 and the bonding module 104. Other bonding-related components such as an interface and a MIB have not been explicitly shown in FIG. 5 so as to avoid congestion, but may be provided in some embodiments to support communication link bonding management and bonding functions.

The bonding manager 102 and the bonding module 104 operate substantially as described above to enable bonding of communication links 114, 116 at a bonding or merge point 106 so as to provide an aggregate communication traffic rate on a further communication link 112. In the system of FIG. 5, the bonded communication links 114, 116 of the group 98 traverse another network element, the subtending network element 92. A system as shown in FIG. 5 allows the hub network element 90 to provide communication link bonding functions for one or more subtending network elements 92, 94, 96.

A system architecture as shown in FIG. 5 may be particularly useful in a hub ASAM, for example, to provide bonding functions for multiple subtending ASAMs which are lacking local bonding capabilities. Deploying a hub ASAM upstream of subtending ASAMs is thus one possible option for supporting communication link bonding on a substantial base of existing ASAMs, without adding explicit bonding support at each existing ASAM.

Variations of the hub-based bonding architecture shown in FIG. 5 will be apparent to those skilled in the art. For example, the hub network element 90 may also, in some embodiments, service CPEs which are more directly coupled to its communication link termination modules 108, 110, and provide communication link bonding for both subtending network elements and these “local” CPEs. Other variations include providing the bonding module 104 at a server module, as shown in FIG. 3, or at one or more of the communication link termination modules 108, 110, as shown in FIG. 4.

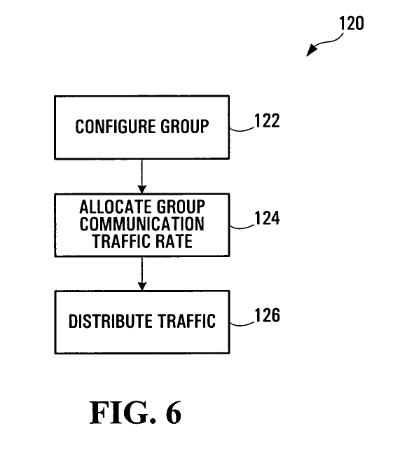

FIG. 6 is a flow diagram of a method according to an embodiment of the invention. The method 120 begins at 122 with a step of configuring multiple communication links as a group for providing an aggregate group communication traffic rate. At 124, the aggregate group communication traffic rate is allocated among the plurality of communication links. Rate allocations for the communication links in a group may be predetermined, automatically determined, or manually configured. The method then proceeds at 126 with an operation of distributing communication traffic to communication link termination modules which transfer communication traffic on the grouped communication links, in accordance with the communication traffic rate allocation.

As described above, communication traffic rate allocations for a bonding group may be manually configured or automatically determined. In the case of manual configuration, each communication link to be included in a bonding group is initialized with a corresponding per-link communication traffic rate. Provided all of the links of the group initialize, which for DSL connections is generally termed reaching “showtime”, or the per-link communication traffic rates on initialized links are sufficient for a planned aggregate group communication traffic rate, then the group becomes operational. Otherwise, if not all links initialize and/or the total of all communication traffic rates of initialized links is below the planned aggregate group rate, alarms may be raised and appropriate actions taken, such as to provision additional communication links for the group.

An illustrative example of automatic communication rate allocation will now be described for the general case of N communication links in a bonding group for which a minimum aggregate group communication traffic rate MIN_{G} and a maximum communication traffic rate MAX_{G} are specified or requested by a customer. The customer may also specify the number of communication links, and possibly particular links, to be included in the group.

According to one embodiment of the invention, minimum and maximum communication rates MINᵢ=0 and MAXᵢ=MAX_{G} (i=1 to N) are set for each of the N communication links. As each communication link is initialized by establishing communications on the link, an attainable communication traffic rate of the link may be determined.

These operations may involve interaction between a bonding manager and an access communication link manager such as a DSL manager or DSL modems in a DSL chipset. For example, a bonding manager may send configuration information for the initialization communication traffic rates to a DSL manager and retrieve per-link operational data, including attainable rate, from the DSL chipset via the DSL manager once each DSL connection reaches showtime (or fails to initialize). The particular implementation details for attainable rate determination may vary between communication link termination modules, LT cards, and types of communication link.

The above communication link initialization operations may be considered a first stage or phase of communication traffic rate allocation. A second stage of rate allocation proceeds after link initialization and attainable rate determination. In the case of DSL links, the second stage of rate allocation is performed after the links reach showtime and attainable rates have been determined.

In the second stage, communication traffic rate allocations are calculated, based on a communication traffic rate splitting ratio

$${X}_{i} = {ATT}_{i} / {\sum }_{1}^{N} {ATT}_{n} ,$$

where ATTᵢ is the attainable communication traffic rate of the i^{th} communication link, for example.

As noted above for manual rate allocation, various alarms may be raised in the event of communication link initialization failures or if the sum of attainable rates on initialized lines is less than the minimum aggregate group communication traffic rate, MIN_{G}.

A bonding group becomes operational after the bonded communication links reach showtime, or more generally, after the links are initialized. Operating communication rates which are set for each communication link may depend on a rate adaptation mode of the communication links. For instance, a minimum communication traffic rate, or both minimum and maximum communication traffic rates, may be set for a particular link as MINᵢ=Xᵢ×MIN_{G}, or MINᵢ=Xᵢ×MIN_{G} and MAXᵢ=Xᵢ×MAX_{G}, depending on the rate adaptation mode of the link. These operating settings, like the initialization settings described above, may be configured through interaction with a DSL manager for example.

System-level communication link bonding as disclosed herein may provide greater flexibility than lower level bonding techniques such as the chipset- and communication link termination-level bonding disclosed in the co-pending application referenced above. Embodiments of the present invention allow any lines in communication equipment to be bonded in a group, and may also be used to support bonding features over an existing installed base of communication link termination components and other types of equipment which do not support bonding. Hub-based bonding provides the potential for a service provider to bond any communication links within its entire network.

Communication link bonding may have particular commercial value in that it addresses an important area of communication services such as DSL services, namely increasing DSL service rate and reach. This is important to provide higher access link bandwidth to existing subscribers, and hence the potential for higher service revenues through enhanced multi-tier pricing, and to reach hitherto unreachable areas to expand the subscriber base.

What has been described is merely illustrative of the application of principles of the invention. Other arrangements and methods can be implemented by those skilled in the art without departing from the scope of the present invention.

For example, FIGS. 1-5 include references to communication networks, network elements, and network termination modules. The present invention may, however, be implemented in conjunction with other types of communication link, which need not necessarily traverse a network.

In addition, FIGS. 2-5 illustrate bonding of communication links which are provided by different communication link termination modules in communication equipment. As described above, however, embodiments of the invention may provide for system-level bonding, and accordingly a bonding group may include communication links which are provided by one, or more than one, communication link termination module.

The present invention is also not restricted to any particular transfer mechanisms or physical media, and may be used with wired or wireless communication links for instance.

Any description herein of ATM-based bonding is intended solely for illustrative purposes. Embodiments of the invention may be applied to Ethernet- and packet-based bonding, for instance, in which Ethernet frames and packets, respectively, are used as transmission data units for communications with CPEs. Ethernet-based bonding may use techniques as described in the Institute of Electrical and Electronics Engineers (IEEE) specification 802.3ah or the ITU Recommendation G.998.2, for example. In general, communication traffic may be reformatted into virtually any type of variable size bonding fragments in a bonding transmission data unit. Each bonding data unit, which would be ATM cells, Ethernet frames, and packets for ATM-, Ethernet-, and packet-based bonding, respectively, may include a fragmented or entire un-fragmented communication traffic PDU. Encapsulation and other processing of communication traffic PDUs and bonding data units, such as to add DA, SA, Ethertype, VLAN, and Frame Check Sequence (FCS) to Ethernet PDUs in Ethernet-based bonding, will be apparent to those skilled in the art.

Different bonding unit formats than those described above are also contemplated. For example, although parts of normal headers of ATM cells or Ethernet frames can be used for bonding-related addresses and other information, an additional bonding header may also or instead be added to bonding transmission data units.

References to communication links should also be interpreted broadly, to include physical media such as DSL lines or logical connections such as communication channels. A single physical bearer may include multiple channels, for example, which may be separately bonded into different groups.

The foregoing description concentrates primarily on service provider communication equipment, illustratively ASAMs. CPEs may operate in a substantially similar manner, although implementation of embodiments of the invention at service provider equipment does not require that the same communication traffic rate allocation techniques, for instance, be applied at a CPE for upstream communications.

It should also be appreciated that multiple bonding groups may be configured at communication equipment in accordance with embodiments of the invention.

Implementation of communication link bonding in communication equipment preferably does not preclude the handling of native communication traffic in addition to bonding communication traffic. Thus, an internal bus in a communication device may transfer both bonding communications, including bonding communication traffic and other bonding-related information such as backpressuring information, as well as non-bonding communications. In this case, it may be desirable to assign different priorities to bonding and non-bonding communications, so that bonding communications have a higher priority on the internal bus for instance. Suitable priority mechanisms for implementing this feature will be dependent upon the type of internal bus and the particular transfer mechanisms it supports, and will also be apparent to those skilled in the art.

In addition, although described primarily in the context of methods and systems, other implementations of embodiments of the invention are also contemplated, as instructions stored on a machine-readable medium for example.

We claim:

1. Apparatus for managing transfer of communication traffic over communication links, for use in communication equipment comprising communication link termination modules adapted to process communication traffic for transfer between respective sets of at least one communication link transceiver and a further communication link on internal communication means, the apparatus comprising:
a communication link bonding manager adapted to configure a plurality of communication links, on which communication link transceivers of the communication link termination modules are adapted to transfer communication traffic, as a group for providing an aggregate group communication traffic rate on the further communication link; and
a bonding module for connection to the internal communication means to distribute on the internal communication means communication traffic received on the further communication link among, and to receive on the internal communication means communication traffic to be sent on the further communication link from, communication link termination modules comprising the communication link transceivers which are adapted to transfer communication traffic on the plurality of communication links.

2. The apparatus of claim 1, wherein the bonding module is adapted to distribute the communication traffic in a sequence of transmission data units for transmission on the plurality of communication links, and is further adapted to include in each of the transmission data units a sequence identifier indicating a position of the transmission data unit in the sequence of transmission data units.

3. The apparatus of claim 1, wherein the bonding module is adapted to receive communication traffic from the communication link termination modules in transmission data units comprising respective sequence identifiers indicating a sequence of the transmission data units, and to merge the received transmission data units in the sequence indicated by the sequence identifiers into an aggregate communication traffic stream.

4. The apparatus of claim 1, wherein the bonding module and at least one of the communication link termination modules are implemented in different field replaceable elements of the communication equipment.

5. The apparatus of claim 1, wherein the internal communication means is shared by the communication link termination modules for carrying internal bonding communications between the bonding module and the communication link termination modules, and internal non-bonding communications.

6. The apparatus of claim 5, wherein the internal bonding communications have a higher priority than the internal non-bonding communications on the internal communication means.

7. The apparatus of claim 5, wherein the internal bonding communications further include information relating to receive and transmit capabilities, and associated delay, of at least one of the plurality of communication links.

8. The apparatus of claim 4, wherein the internal communication means comprises a switch fabric capable of handling Ethernet Protocol Data Units.

9. The apparatus of claim 1, wherein at least the bonding module is implemented in a network termination module, the network termination module being adapted to transfer communication traffic between the further communication link and the internal communication means.

10. The apparatus of claim 1, wherein the bonding module is implemented in an intermediate module, the intermediate module being adapted to transfer communication traffic between a network termination module, which is adapted to transfer communication traffic on the further communication link, and the communication link termination modules on the internal communication means.

11. The apparatus of claim 10, wherein the network termination module comprises the communication link communication link bonding manager.

12. The apparatus of claim 1, wherein at least the bonding module is implemented in one of the communication link termination modules.

13. The apparatus of claim 1, wherein the bonding module is further adapted to format communication traffic received on the further communication link into Asynchronous Transfer Mode (ATM) cells, to remove redundant information from headers of the ATM cells, and to add addressing information to the ATM cells.

14. The apparatus of claim 8, wherein the communication link termination modules and the bonding module are addressable by respective Source and Destination Media Access Control addresses (SA/DA MAC), and wherein the internal bonding communications are identified by a dedicated Virtual Local Area Network (VLAN) tag.

15. The apparatus of claim 5, wherein the internal bonding communications comprise Ethernet frames, each Ethernet frame encapsulating a respective Asynchronous Transfer Mode (ATM) cell.

16. The apparatus of claim 1, further comprising:
an interface for receiving user inputs,
wherein the communication link bonding manager is adapted to configure the group by storing information in a Management Information Base (MIB) responsive to the user inputs.

17. A hub communication network element comprising the apparatus of claim 1, the hub communication network element being adapted to be operatively coupled to a subtending communication network element, and to establish the plurality of communication links between the bonding module and a remote bonding module via the subtending communication network element, the hub communication network element thereby supporting communication link bonding for the subtending communication network element.

18. A method of managing transfer of communication traffic over communication links at a communication device which comprises communication link termination modules adapted to process communication traffic for transfer between respective sets of at least one communication link transceiver and a further communication link on internal communication means, the method comprising:
configuring a plurality of communication links, on which communication link transceivers of the communication link termination modules are adapted to transfer communication traffic, as a group for providing an aggregate group communication traffic rate on the further communication link; and
distributing on the internal communication means communication traffic received on the further communication link among, and receiving on the internal communication means communication traffic to be sent on the further communication link from, communication link termination modules comprising the communication link transceivers which are adapted to transfer communication traffic on the plurality of communication links.

19. A machine-readable medium storing instructions which when executed perform the method of claim 18.

20. A communication device comprising:
internal communication means;
a network termination device, operatively coupled to the internal communication means, for transferring communication traffic between a communication network and the internal communication means;
a plurality of line termination devices, operatively coupled to the network termination device through the internal communication means and comprising transceivers to be operatively coupled to communication lines, for processing communication traffic for transfer between the network termination device and the transceivers on the internal communication means; and
bonding means for configuring a plurality of the communication lines as a bonding group to provide an aggregate group communication traffic rate, and for distributing on the internal communication means communication traffic received from the communication network to, and receiving on the internal communication means communication traffic to be sent on the further communication link from, each of the plurality of line termination devices comprising transceivers for transferring communication traffic on any of the plurality of communication lines of the bonding group.

21. The communication device of claim 20, wherein the network termination device or each of at least one of the plurality of line termination devices comprises the bonding means.

22. The communication device of claim 20, wherein the network termination device and at least one of the plurality of line termination devices implement respective functions of the bonding means, the network termination device comprising means for configuring the bonding group, and each of the at least one of the plurality of line termination devices comprising means for distributing communication traffic.

23. The communication device of claim 20, further comprising:
a bonding server module operatively coupled to the network termination device and to the plurality of line termination devices, the bonding server module comprising the bonding means.

24. The communication device of claim 20, further comprising:
a bonding server module operatively coupled to the network termination device and to the plurality of line termination devices,
wherein respective functions of the bonding means are implemented in the network termination device and the bonding server module, the network termination device comprising means for configuring the bonding group, and the bonding server module comprising means for distributing communication traffic.

25. A hub communication network element comprising the communication device of claim 20, wherein at least a subset of the communication lines are for operatively coupling the hub communication network element to a subtending communication network element to thereby provide a bonding function for the subtending communication network element.

26. The hub communication network element of claim 25, wherein multiple subsets of the communication lines are operatively coupled to respective subtending communication network elements, wherein configuring comprises configuring communication lines of each subset as respective bonding groups, and wherein distributing comprises distributing communication traffic for each bonding group, the bonding means thereby providing a bonding function for each of the subtending communication network elements.
